(19) United States
(12) Patent Application Publication
(10) Pub. No.: US 2025/0208492 A1
(43) Pub. Date: Jun. 26, 2025

(54) OPTICAL FILTER MOUNT

(71) Applicant: SETTES B.V., Amsterdam (NL)

(72) Inventor: Stevie VOS, Amsterdam (NL)

(73) Assignee: SETTES B.V., Amsterdam (NL)

(21) Appl. No.: 18/851,110

(22) PCT Filed: Mar. 29, 2022
(86) PCT No.: PCT/EP2022/058257

§ 371 Date: Sep. 26, 2024

(51) Int. Cl. G03B 17/56; G03B 11/00

(52) U.S. Cl. CPC G03B 17/565; G03B 11/00

(57) ABSTRACT

An optical filter mount is provided for positioning an optical filter in front of a lens of a camera. The optical filter mount comprises a mounting frame, with a lens connection mechanism for connecting the mounting frame to the lens of the camera. The optical filter mount comprises one or more connection members arranged for connecting the optical filter or the optical filter adapter to the mounting frame, wherein the one or more connection members form at least one loop into which the optical filter or optical filter adapter can be positioned.

### TECHNICAL FIELD

The aspects and embodiments thereof relate to the field of filter mounts for mounting optical filters in front of a lens of a camera.

### BACKGROUND

In the field of photography, film and videography, it may be required to position an optical filter in front of a lens of a camera. Such a filter may be used to provide different optical effects, such as polarization, colour correction, or diffusion, which diffusion is used to for example flatter skin, raise shadows, and/or create a classic cinematic style.

In order to position such an optical filter in front of the lens of the camera, such that light entering the lens first passes through the filter, a matte box is used. A matte box can act as a filter holder, and can be mounted in front of a lens. In use, a filter may first be placed in a filter tray, and subsequently the filter tray with the filter is slid into a frame of the matte box. Alternatively, a filter may be connected directly to the matte box, for example with one or more spring-loaded clamps.

As an alternative to using a matte box to position an optical filter in front of a lens of a camera, it has been proposed to use single-sided or double-sided adhesive tape to temporarily connect the optical filter directly to a lens.

### SUMMARY

It is observed that matte boxes can be bulky, and thus add significant volume and/or mass to a camera and lens combination. This bulkiness may hinder the operator of the camera, which is particularly observed when the lens has to be positioned close to an object which is to be photographed or filmed and/or when the camera is used in a confined space such as the interior of a car, as the matte box may protrude a significant distance outward away from the lens towards the object which is to be photographed or filmed. It is further observed that the presence of a matte box may hinder a camera operator when shooting an over the shoulder shot, wherein the matte box may collide with the head of an actor of whom a rear of the head is shot. A matte box can for example be bulky due to the presence of one or more flags attached to the matte box.

It is observed that the method of using adhesive tape to position the optical filter in front of the lens has several disadvantages. For example, this method may have disadvantages in that it may be difficult to properly connect the filter to the lens, it may take a significant amount of time to connect the filter to the lens, especially during busy filming days with a tight schedule, and/or the adhesive tape may leave adhesive residue behind on the lens and/or filter after the filter is removed again from the lens. Furthermore, the connection between the optical filter and the lens may be unstable, and when the adhesive accidentally becomes loosened, the optical filter may fall off the lens and become damaged.

It is an object of the present disclosure to provide for an optical filter mount which allows convenient mounting of an optical filter in front of a camera lens, which preferably at least partially solves one of problems disclosed with known filter mounts or at least provides an alternative way of mounting the optical filter in front of the camera lens.

A first aspect provides an optical filter mount for positioning an optical filter in front of a lens of a camera. The optical filter mount comprises a mounting frame, with a lens connection mechanism for connecting the mounting frame to the lens of the camera. The optical filter mount comprises one or more connection members arranged for connecting the optical filter or the optical filter adapter to the mounting frame, wherein the one or more connection members form at least one loop into which the optical filter or optical filter adapter can be positioned.

It will be understood that in general, also multiple optical filters and/or multiple optical filter adapters can be positioned in front of the lens using the optical filter mount. The multiple optical filters and/or one or more optical filter adapters may for example be stacked one behind the other. In general, an optical filter may for example be rectangular, square, or even round. A rectangular filter may for example have a width of about 10 cm or 4 inches and a height of about 14 cm or 5.65 inches.

By virtue of the optical filter mount according to the first aspect, a compact means of positioning the optical filter or optical filter adapter may be obtained. Because the optical filter or optical filter adapter can be positioned into at least one loop, the optical filter or optical filter adapter can be connected securely to the lens via the mounting frame. Furthermore, positioning the optical filter or optical filter adapter into the at least one loop can be convenient for a user, and may for example require less time than using adhesive tape for connecting the optical filter to the lens.

As an option, the one or more connection members may form at least two loops into which the optical filter or the optical filter adapter can be positioned. As a further option, the one or more connection members may form at least four loops into which the optical filter or the optical filter adapter can be positioned. It will be understood that although a single loop may be sufficient for connecting the optical filter or optical filter adapter to the mounting frame, multiple loops may allow for an even more secure connection.

A loop may be generally defined as a section of a connection member which is curved. In particular, a loop may be a closed loop or a partially open loop. When the loop is a partially open loop, a closed loop shape may be formed by the partially open loop formed by a connection member together with another part of the filter mount, such as the mounting frame.

When an optical filter or an optical filter adapter is positioned into a loop, said loop may hold the optical filter or optical filter adapter in place. In general, the one or more connection members are directly or indirectly connected to the mounting frame. As such, when an optical filter or an optical filter adapter is positioned into a loop, said loop may hold the optical filter or optical filter adapter in place relative to the mounting frame, and thus in use relative to a lens to which the mounting frame is connected. Preferably, and in general, the connection between the mounting frame and the lens is a substantially rigid connection.

When the filter mount comprises at least two connection members, each connection member may form at least one loop. For example, the filter mount may comprise two connection members, both of which form two loops. More in general, at least one of the connection members may form at least two loops.

When the filter mount comprises at least two loops, these loops may be positioned on opposite sides of the mounting frame. This may allow for a more secure positioning of the optical filter or optical filter adapter relative to the mounting frame.

At least one or even all of the one or more connection members may be or comprise an elongated member, arranged to be resiliently elongated, such as an elastic band, elastic strap, elastic belt, or elastic ribbon. In particular, at least a part or parts of a connection member forming a loop may be or comprise an elongated member, arranged to be resiliently elongated, such as an elastic band. By virtue of resiliently elongating at least part of a loop of a connection member, an optical filter or optical filter adapter positioned into said loop may be clamped, pushed, pressed or pulled towards or against the mounting frame, which may allow for a more secure positioning of the optical filter or optical filter adapter relative to the mounting frame.

In general, an elongated member, such as an elastic band, may comprise one or more elongated strands, of which at least part may be elastically elongated in use. An elongated member may comprise elastic material such as rubber, any elastomer, or any other material which is elastically deformable, preferably by a single camera operator, even more preferably using one hand. Furthermore in general, an elongated member may be elastically strechted out more than 10% of its unstretched length, more than 20%, more than 50%, or even more than 100%.

As a particular option, a loop may be internally disconnected and connected again. As such, a loop may be disconnected to allow positioning of the optical filter or optical filter adapter, and reconnected to fix the optical filter or optical filter adapter into the loop. For example, the loop may be opened and closed alike a belt.

In particular when a connection member is or comprises an elongated member, a first end of a connection members may be connected to the mounting frame, and a second end of the one of the connection members is may be a free end. A free end of the connection member may be protruding relative to the filter mount, and when the connection member is at least partially resilient or flexible, the free end may dangle or hang away from the filter mount.

As a particular option, embodiments of the optical filter mount may comprise one or more clamps with which one or more free ends may be connected to the optical filter mount, for example to the mounting frame. This may prevent the one or more free ends from dangling freely, and for example getting caught in a focus motor, or hinderingly colliding with an optical filter held by the optical filter mount—which may cause undesired sounds.

To allow one or more loops to be changed in shape, for example tightened or loosened, embodiment of the filter mounts may comprise a tightening mechanism for tightening at least one of the loops. The at least one of the loops may for example be tightened after an optical filter or optical filter adapter is positioned into said loop, for securing the optical filter or optical filter adapter better to the mounting frame.

As an option, when a connection member comprises a free end, the tightening mechanism may comprise a clamp, such as a wedge shaped slit, into which the free end of the connection member can be clamped. This clamping may prevent loosening of one or more loops formed by said connection member.

For example in order to protect part of at least one of the connection members, to prevent or reduce contact with at least one of the connection members, and/or to provide for a more compact filter mount, part of at least one of the connection members may extend through the mounting frame.

The mounting frame may comprise an open ring frame, and the lens connection mechanism may be arranged for closing the open ring frame, such that the open ring frame can be clamped onto a lens.

In general, a lens has a generally cylindrically shaped lens body. An outer diameter—also known as a front diameter—of such a lens body may typically be between 80 mm and 120 mm, for example 87 mm, 95 mm, 110 mm, 114 mm, 160 mm, or any other value. As such, an inner diameter of the open ring frame may generally correspond to one of these diameters.

A step down ring may be positioned between the lens body and the mounting frame, which step down ring has an outer diameter corresponding to an inner diameter of the mounting frame, and an inner diameter corresponding to an outer diameter of the lens body. One or more of such step down rings may be provided in a set of parts, which set of parts also comprises an embodiment of an optical filter mount.

A second aspect provides an optical filter mount assembly, comprising any optical filter mount according to the first aspect, and claims and an optical filter or an optical filter adapter, wherein the optical filter or the optical filter adapter is positioned into at least one loop of the optical filter mount.

A width and/or a height of the optical filter mount assembly may be essentially determined by a width and/or a height of the optical filter or the optical filter adapter. As such, in a compact manner, an optical filter or an optical filter adapter can be mounted to a lens by virtue of the optical filter mount of the first aspect.

In general, it is observed that it may be difficult to position a round or generally non-cuboid optical filter into one or more loops of an optical filter mount. A third aspect provides an optical filter adapter, in particular suitable for use in an assembly according to the second aspect. The optical filter adapter comprises an adapter frame arranged for accommodating a non-cuboid optical filter, such as a round optical filter, which adapter frame is arranged to be positioned inside at least one loop of an optical filter mount, in particular an optical filter mount according to the first aspect.

It will be understood that in the present disclosure, the term optical filter also encompasses diopters and split diopters, which may be generally cylindrically shaped or even shaped as part of a cylinder.

The adapter frame may be generally cuboid-shaped. Additionally or alternatively, the optical filter adapter may comprise at least one hook arranged to be positioned into a loop of an optical filter mount. The loop may wrap around the hook, thereby generally fixing a position of the adapter frame relative to the mounting frame of the optical filter mount.

A fourth aspect provides an alternative optical filter adapter for use in an assembly according to the second aspect. The optical filter adapter comprises an adapter frame arranged for accommodating an optical filter, and further comprises an aperture through the adapter frame, and one or more light-blocking elements adjacent to the aperture, in particular surrounding the aperture. The one or more light-blocking elements may in use prevent light from entering the optical filter from the rear side of the optical filter, which light may reflect through the optical filter into the lens. This reflecting may in general be undesired.

A fifth aspect provides a lens assembly for use with a camera, comprising a lens, and an optical filter mount according to the first aspect or an optical filter mount assembly according to the second aspect, wherein the optical filter mount or optical filter mount assembly is positioned in front of the lens, and light can pass through the optical filter mount or optical filter mount assembly into the lens.

A sixth aspect provides a camera assembly, comprising a camera and a lens assembly according to the fifth aspect. The camera may be a camera for taking photos and/or shooting video, analogue or digital.

A seventh aspect provides a method of mounting an optical filter or an optical filter adapter to a lens of a camera. The method comprises steps of connecting a mounting frame of an optical filter mount to the lens of the camera, and positioning the optical filter or the optical filter adapter between the mounting frame and at least one loop of the optical filter mount.

By virtue of the method according to the seventh aspect, a method may be obtained with which the one or more optical filters and/or optical filter adapters can be conveniently positioned and held in front of the lens of the camera. The method may be quicker than a known method, and/or may provide for a more secure connection between the one or more optical filters or optical filter adapters and the lens. Additionally, or alternatively, the method may result in a more compact and/or less bulky and/or lighter lens assembly.

In embodiments of the method, the one or more optical filters and/or one or more optical filter adapters are pressed against the mounting frame by the at least one loop being elastically deformed. Being pressed against the mounting frame may further secure a position of the one or more optical filters and/or one or more optical filter adapters relative to the mounting frame, and thus relative to the lens.

For example to position the one or more optical filters and/or one or more optical filter adapters in a specific orientation relative to the lens, and/or to further secure a connection between the one or more optical filters and/or one or more optical filter adapters, embodiments of the method may comprise tightening the at least one loop of the optical filter mount, in particular after positioning the one or more optical filters and/or one or more optical filter adapters between the mounting frame and said at least one loop.

It will be understood that different options disclosed in conjunction with a single aspect may be generally applied in any combination in embodiments of said aspect. Furthermore, different options disclosed in conjunction with one of the aspects may be readily applied to embodiments of another of the aspects, in any combination, where applicable.

### BRIEF DESCRIPTION OF THE FIGURES

In the figures,

FIG. 1 shows in an isometric view an embodiment of a lens assembly;

FIG. 2A schematically shows in a front view an embodiment of an optical filter mount;

FIG. 2B shows in a front view an embodiment of an optical filter mount;

FIG. 3 shows in an isometric view another embodiment of a lens assembly;

FIG. 4. shows in a front view another embodiment of an optical filter mount;

FIG. 5A schematically shows in a front view an optical filter adapter; and

FIG. 5B schematically shows yet another embodiment of an optical filter mount assembly.

### DETAILED DESCRIPTION OF THE FIGURES

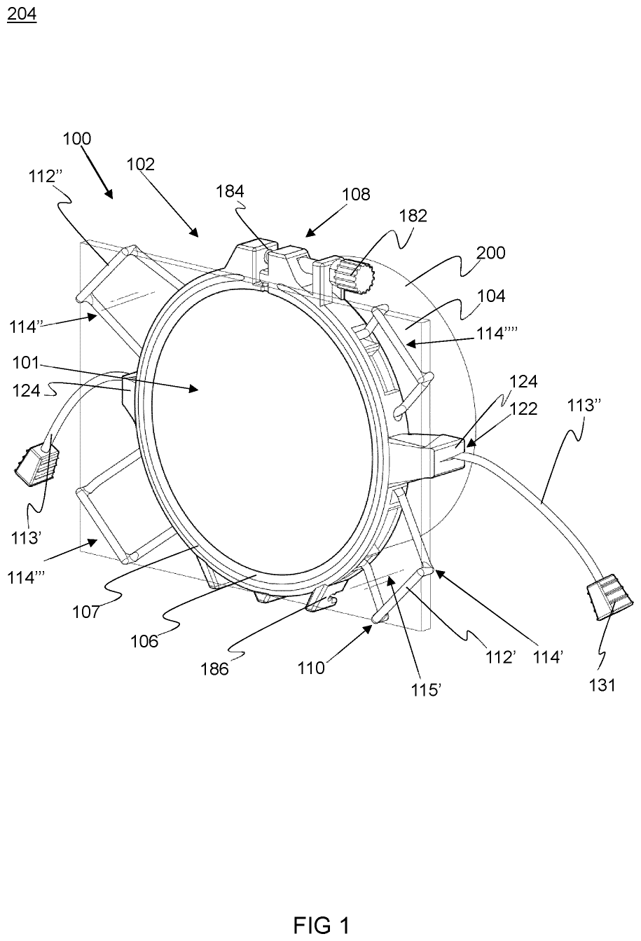

FIG. 1 shows in an isometric view an embodiment of a lens assembly 204, with an optical filter mount assembly 100, with a particular embodiment of an optical filter mount 102 carrying an optical filter 104. The optical filter mount 102 is depicted connected to a lens 200, which lens 200 is only schematically depicted as a cylindrically shaped body. The optical filter 104 is generally shaped as a cuboid, which resembles a rectangle in a front view. In FIG. 1, the optical filter 104 is shown as a transparent wireframe.

The mounting frame 106 is arranged to be clamped onto a cylindrical lens 200, and as such comprises a generally circular aperture 101. This circular aperture 101 together with the cylindrical lens allows the optical filter mount 102 to be attached to the lens 200 in several orientations. This in turn allows an optical filter to be positioned in e.g. a portrait-or landscape mode if required. Furthermore, the aperture 101 through the mounting frame 106 allows light to pass through the mounting frame 106, into the lens 200.

For clamping the mounting frame 106 onto the cylindrical lens 200, a lens connection mechanism 108 may be provided. In the embodiment of FIG. 1, the lens connection mechanism 108 comprises a screw 182, which can be screwed into a threaded hole 184. By threading the screw 182 into the hole 184, a diameter of the mounting frame 106 can be reduced, and the mounting frame 106 can be clamped onto the lens 200. It will be understood that also other lens connection mechanisms 108 are envisioned, for example comprising one or more resilient or elastic members, such as a resilient ring, which can be slid onto the lens, elastically deformed by the lens, and can as such clamp the mounting frame 106 onto the lens 200. In general, the connection between the mounting frame and the lens is preferably releasable.

In the example of FIG. 1, an optical filter 104 is held by the optical filter mount 102. Because the optical filter 104 is held by the optical filter mount 102, and the optical filter mount 102 is connected to the lens 200, the optical filter 104 can be positioned in front of the lens 102. As such, light can pass first through the optical filter 104 and subsequently can enter the lens 200.

Although throughout the figures, only a single optical filter 104 is depicted to be held by the optical filter mount 102, it will be understood that also multiple optical filters can be held simultaneously by an optical filter mount 102, for example when the multiple optical filters are stacked behind one another. As such, light can pass through these multiple optical filters before entering the lens.

In the particular embodiment of FIG. 1, the optical filter 104 is positioned and held in four loops 114′, 114″, 114′″, 114″″. These loops 114 hold the optical filter 104 at four corners of the optical filter 104. The loops 114 are formed by parts of two connection members 112′, 112″, which in this embodiment are elongated members, in particular elastic bands. A loop 114′ may define an opening 115′ or aperture, into which part of an optical filter or optical filter adapted can be positioned.

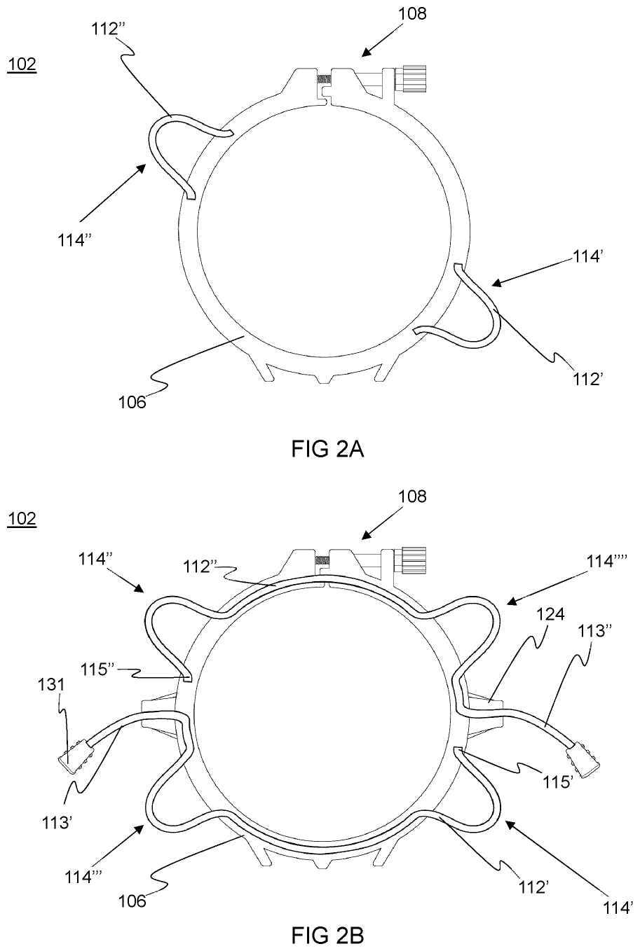

The loops 114 are generally formed by one or more connection members. In the particular embodiment of FIG. 1—as will be elaborated on in conjunction with FIG. 2B—the four loops 114 are formed by two connection members 112′ and 112″, with two loops per connection member. It will be understood that other embodiments of optical filter mounts are envisioned, comprising any number of connection members, for example one, two, three, four, or even more, which connection member or connection members form any number of loops, for example one, two, three, four or even more, in any combination thereof.

The loops 114″ and 114″″ can be tightened by pulling on a free end 113″ of the connection member 112″ forming said loops. In order to hold a section of the connection member 112″ between a fixed end 115″ thereof and the free end 113″ in place, an optional tightening mechanism 122 is provided. The fixed end 115″ is for example visible in FIG. 2B.

In the embodiment of FIG. 1, the tightening mechanism 122 is formed by the free end 113″ of the connection member 112″, and a clamp 124 into which the connection member 112″ may be clamped. The clamp 124 is formed as a wedged slit, but in general, and other clamping mechanism may be used as a clamp. A single clamp may be used for multiple connection members, or, as in the embodiment of FIG. 1, each connection member is provided with a separate clamp. It will be understood that as a connection member 112″ is tightened further, a smaller part of the connection member 112″ may be held between the fixed end 115″ and the clamp 124, and a length of the free end 113″ may increase.

Because the tightening mechanism or tightening mechanisms 122 allow for the size of one or more of the loops 114′, 114″, 114′″, 114″″″ to be adjusted, a position of the filter 104 relative to the mounting frame 106, and in use relative to the lens 200, may be adjusted by loosening or tightening one or more of the connection members. Such positioning may be preferred when different parts of the optical filter provide a different effect, such as a gradually changing colour filter.

As an option, for example depicted in FIG. 1, the filter mount 102 comprises a further clamping member 186, arranged to hold part of one or more of the connection members 112, in particular free ends 113 thereof, in order to prevent uncontrolled dangling of said free ends.

As a further option, for example shown in FIG. 1, a gripping member 131 may be provided at or near an outer end of a free end 113″. The gripping member 131 may be a thickened member relative to the connection member 112″, and may allow a user to more conveniently grasp the connection member 112″, for example for tightening one or more loops formed by said connection member 112″. A gripping member 131 may comprise a high friction material, such as rubber, and/or may be provided with one or more surface features, such one or more gripping protrusions.

It may be preferred to in use clamp the optical filter 104 or optical filter adapter 300 against the mounting frame 106—as shown in FIG. 1—instead of against the connection members. To this end, at least part of a front-facing surface 107 of the mounting frame 106 may be at least partially covered with a soft material, which may prevent scratching of the optical filter in use, and/or a high friction material, which may aid in holding the optical filter in place relative to the mounting frame 106. The at least part of a front-facing surface 107 may for example comprise rubber as a soft and high friction material.

FIG. 2A schematically shows in a front view an alternative embodiment of an optical filter mount 102. This particular embodiment comprises two connection members 112′, 112″, which each form a loop 114′, 114″. The connection members 112′, 112″ may for example be embodied as elastic bands, which can be elongated when tensioned. The connection members 112′, 112″ are shown connected with both outer ends to the mounting frame 106 of the optical filter mount 102. When the connection members 112′, 112″ can be sufficiently elastically elongated, a tightening mechanism may not be required.

FIG. 2B schematically shows in a front view the optical filter mount 102 also shown in FIG. 1, which comprises two connection members 112′, 112″. FIG. 2B in particular shows a section view, such that both connection members 112′, 112″ are visible. As can be seen, both connection members 112′, 112″ form two loops, and thus the optical filter mount 102 comprises four loops 114′, 114″, 114′″, 114″″. In use, at least part of the connection members 112′, 112″ may be covered by a part of the mounting frame 106, which is not shown in FIG. 2B in order to visualise the connection members. That at least part of the connection members 112′, 112″ may be covered is shown for example in FIG. 1. The connection members 112′, 112″ may thus extend through the mounting frame 106.

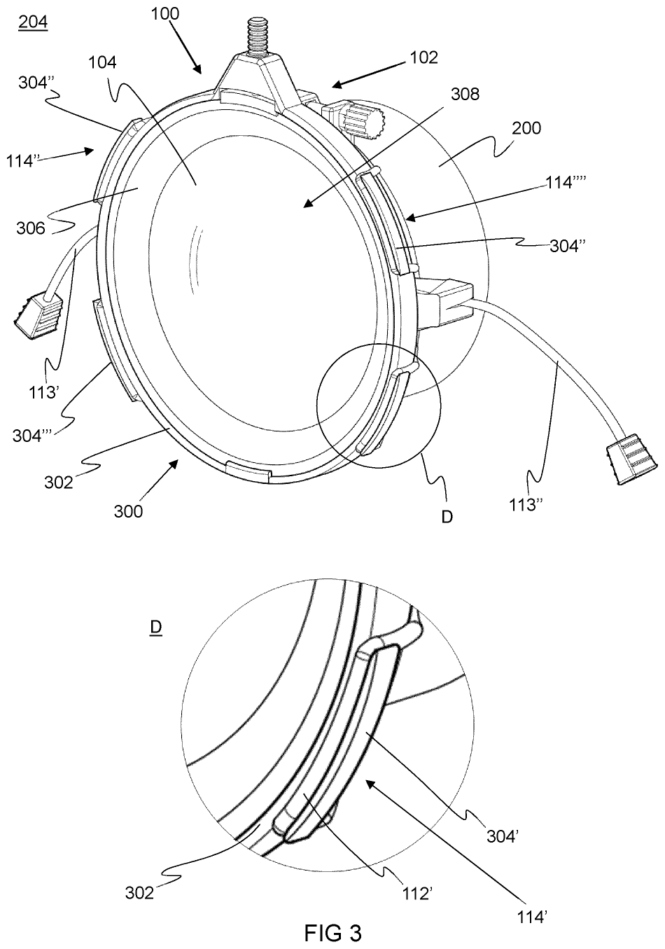

FIG. 3 shows in an isometric view another embodiment of a lens assembly 204, with another embodiment of an optical filter mount assembly 100. FIG. 3 also includes a detailed view D of part of the lens assembly 204. The particular optical filter mount assembly 100 of FIG. 3 comprises a round or flat cylindrical optical filter 104, which may in examples be a diopter. In particular when the loops are positioned on corners of an imaginary square or rectangle, it may be hard or even impossible to positioned said optical filter 104 into the loops. This problem may be solved by using an optical filter adapter 300, an example of which is shown in FIG. 3.

The optical filter adapter 300 comprises an adapter frame 302, which in this embodiment is a generally round adapter frame 302. When the adapter frame 302 is generally round, a compact lens assembly 204 may be obtained. To positioned the optical filter adapter 300 into one or more loops 114 of the optical filter mount 102, the adapter frame 302 comprise one or more hooks 304. The number of hooks 304 is generally equal to or larger than the number of loops 114. In detail D, it is shown that the hook 304′ is securely positioned into the loop 114′.

As an option, the adapter 300 comprises one or more light-blocking elements 306, arranged to prevent light from entering the optical filter 104 from the rear side of the optical filter 104. In the embodiment of FIG. 3, as a particular option, part of the adapter frame 302 forms a light-blocking element 306, surrounding an aperture 308 through the adapter frame 302.

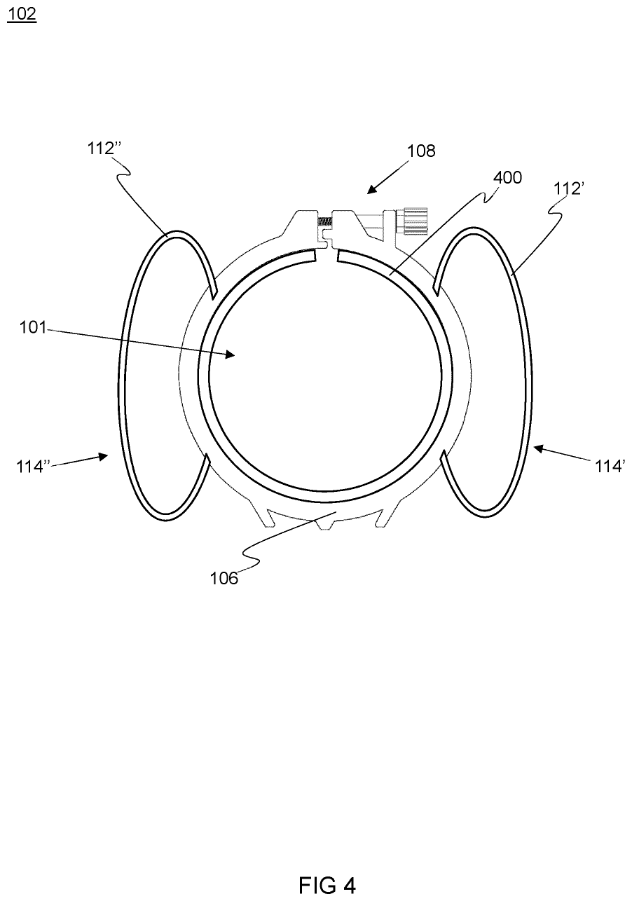

FIG. 4 shows yet another embodiment of an optical filter mount 102, with two loops 114′, 114″ which are sized and positioned differently than the loops for example depicted in FIG. 2A. It will be understood that many different sizes and orientations for loops are envisioned, and the example of the figures should not be interpreted in a limitative way.

FIG. 4 shows an even further option, which is generally applicable in any embodiment of an optical filter mount assembly 100, wherein the assembly 100 comprises one or more step-down rings 400, which allows the mounting frame 106 to be connected onto lenses with an outer diameter which differs from a diameter of the aperture 101 of the mounting frame 106.

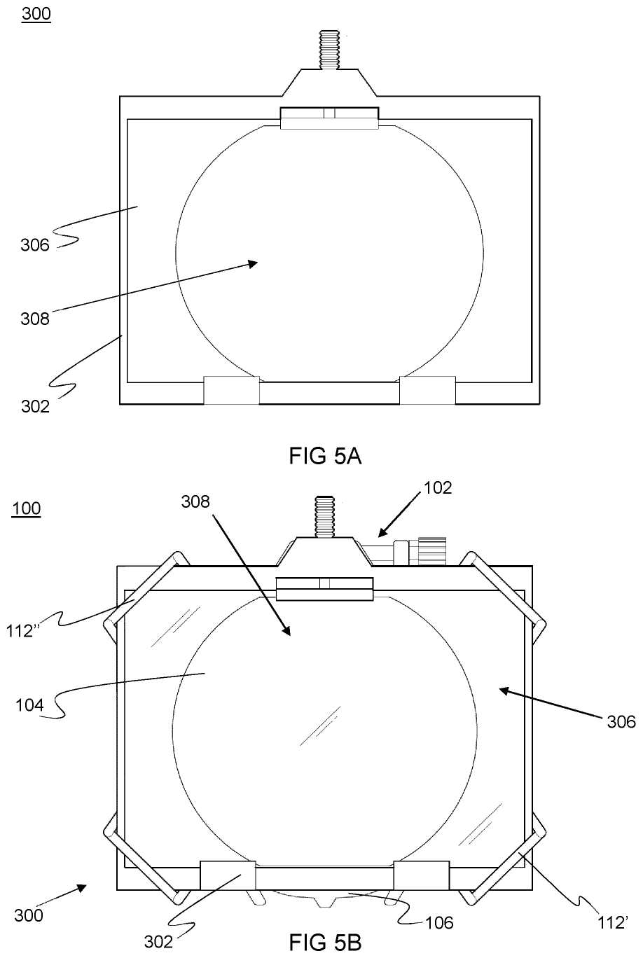

FIG. 5A schematically shows in a front view an embodiment of an optical filter adapter 300, arranged for accommodating an optical filter. The adapter 300 comprises an adapter frame 302, arranged to be positioned into one or more loops of an optical filter mount. The adapter frame 302 further comprising an aperture 308 through the adapter frame, and one or more light-blocking elements 306 adjacent to the aperture 308, in particular surrounding the aperture. In general, an optical filter may be clamped, fitted, or slid into an adapter.

FIG. 5B shows the optical filter adapter 300 held by an embodiment of an optical filter mount 102. In particular, the optical filter adapter 300 is positioned into four loops 104 of the optical filter mount 102.

In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described. The word ‘comprising’ does not exclude the presence of other features or steps. Furthermore, the words ‘a’ and ‘an’ shall not be construed as limited to ‘only one’, but instead are used to mean ‘at least one’, and do not exclude a plurality.

1. An optical filter mount for positioning an optical filter or an optical filter adapter in front of a lens of a camera, the filter mount comprising:
a mounting frame, with a lens connection mechanism for connecting the mounting frame to the lens of the camera; and
one or more connection members arranged for connecting the optical filter or the optical filter adapter to the mounting frame, wherein the one or more connection members form at least one loop into which the optical filter or optical filter adapter can be positioned.

2. The filter mount according to claim 1, wherein the one or more connection members form at least two loops into which the optical filter or the optical filter adapter can be positioned.

3. The filter mount according to claim 1, wherein the one or more connection members form at least four loops behind which the optical filter or the optical filter adapter can be positioned.

4. The filter mount according to claim 1, wherein at least one of the one or more connection members comprises an elongated member, arranged to be resiliently elongated.

5. The filter mount according to claim 2, comprising at least two connection members, each connection member forming at least one loop.

6. The filter mount according to claim 25, wherein at least one of the connection members forms at least two loops.

7. The filter mount according to claim 2, wherein at least two loops are positioned on opposite sides of the mounting frame.

8. The filter mount according to any of the preceding claim 1, wherein a first end of one of the connection members is connected to the mounting frame, and a second end of the one of the connection members is a free end.

9. The filter mount according to claim 1, further comprising a tightening mechanism configured to tighten at least one of the loops.

10. (canceled)

11. The filter mount according to claim 1, wherein part of at least one of the connection members extends through the mounting frame.

12. The filter mount according to claim 1, wherein the mounting frame comprises an open ring frame, and the lens connection mechanism is arranged for closing the open ring frame, such that the open ring frame can be clamped onto a lens.

13. An optical filter mount assembly comprising an optical filter mount according to claim 1 and an optical filter or an optical filter adapter, wherein the optical filter or the optical filter adapter is positioned into at least one loop of the optical filter mount.

14. The optical filter mount assembly according to claim 13, wherein a width and/or a height of the assembly is determined by a width and/or a height of the optical filter or the optical filter adapter.

15. An optical filter adapter for use in an assembly according to claim 13, comprising an adapter frame configured to accommodate a non-cuboid optical filter, wherein the adapter frame is positioned inside at least one loop of an optical filter mount.

16. The optical filter adapter according to claim 15, comprising at least one hook positioned into a loop of an optical filter mount.

17. An optical filter adapter for use in an assembly according to claim 13, comprising;
an adapter frame configured to accommodate arranged for-accommodating-an optical filter;
an aperture through the adapter frame; and
one or more light-blocking elements adjacent to the aperture.

18. A lens assembly for use with a camera, comprising:
a lens; and
an optical filter mount or an optical filter mount assembly.
wherein the optical filter mount is for positioning an optical filter or an optical filter adapter in front of a lens of a camera, the filter mount comprising:
a mounting frame, with a lens connection mechanism for connecting the mounting frame to the lens of the camera; and
one or more connection members arranged for connecting the optical filter or the optical filter adapter to the mounting frame, wherein the one or more connection members form at least one loop into which the optical filter or optical filter adapter can be positioned,
wherein the filter mount assembly comprises an optical filter mount according to claim 1 and an optical filter or an optical filter adapter, wherein the optical filter or the optical filter adapter is positioned into at least one loop of the optical filter mount, and
wherein the optical filter mount or optical filter mount assembly is positioned in front of the lens, and light can pass through the optical filter mount or optical filter mount assembly into the lens.

19. A camera assembly, comprising:
a camera; and
a lens assembly according to claim 18, wherein the lens assembly is connected to the camera.

20. A method of mounting an optical filter or an optical filter adapter to a lens of a camera, comprising steps of:
connecting a mounting frame of an optical filter mount to the lens of the camera; and
positioning the optical filter or the optical filter adapter between the mounting frame and at least one loop of the optical filter mount.

21. The method according to claim 20, wherein the optical filter or the optical filter adapter is pressed against the mounting frame by the at least one loop being elastically deformed.

22. (canceled)
